(19) United States
(12) Patent Application Publication
(10) Pub. No.: US 2024/0320070 A1
(43) Pub. Date: Sep. 26, 2024

(54) METHOD FOR IMPLEMENTING NON-INTRUSIVE COMMUNICATION SERVICE ON ANDROID PLATFORM

(71) Applicant: Huizhou TCL Cloud Internet Corporation Technology Co., Ltd., Huizhou, Guangdong (CN)

(72) Inventor: Guoqiang QIU, Huizhou, Guangdong (CN)

(73) Assignee: Huizhou TCL Cloud Internet Corporation Technology Co., Ltd., Huizhou, Guangdong (CN)

(21) Appl. No.: 18/574,191

(22) PCT Filed: Mar. 10, 2022
(86) PCT No.: PCT/CN2022/080252

§ 371 Date: Dec. 26, 2023

(30) Foreign Application Priority Data
Jun. 30, 2021 (CN) 202110742835.4

(51) Int. Cl. G06F 9/54

(52) U.S. Cl. CPC G06F 9/547; G06F 9/542

(57) ABSTRACT

Disclosed is a method for implementing a non-intrusive communication service on an Android platform, comprising: a communication framework extension layer monitors state change of a Modem module; after detecting a state change, the communication framework extension layer reports the state change to an application layer, and the application layer determines a control operation determined by the state change, converts the control operation into a control instruction, and issues the control instruction to the communication framework extension layer; the communication framework extension layer issues the control instruction to the Modem module, so that the Modem module responds to the control instruction.

### PRIORITY

This PCT patent application claims priority to Chinese Patent Application No. 202110742835.4, filed Jun. 30, 2021, the disclosure of which is incorporated herein by reference in its entirety.

### TECHNICAL FIELD

The present disclosure relates to the field of computer technologies, and in particular, to a method for implementing a non-intrusive communication service on an Android platform.

### BACKGROUND

Since 2019, Google has officially launched an Mainline plan, releasing a binary file of some of modules including a communication service stack (Telephony Stack) to one or more device vendors. For the device vendors, when the communication service stack is redeveloped and customized to meet the requirements of a region and an operator, it is necessary for the device vendors to submit requirement development codes to Google and use the requirement development codes after the requirement development codes are adopted by Google. However, a period of submitting the requirement development codes is longer and an adoption rate for the requirement development codes is lower, so that it is difficult to meet actual requirements.

### SUMMARY

In view of drawbacks of the related art, technical problems to be solved by the present disclosure are to provide a method for implementing a non-intrusive communication service on an Android platform.

In order to solve the above technical problems, a first aspect of an embodiment of the present disclosure provides a method for implementing a non-intrusive communication service on an Android platform, where the method is applied to a terminal device configured with a communication framework extension layer, and the method includes:
invoking a communication service stack loaded by a terminal device to load and initialize a communication framework by using the communication service stack;
loading and initializing, by the communication framework, a communication framework extension layer with a reflection mechanism to enable the communication framework extension layer to invoke and register a Modem module by using a Radio Interface Layer (RIL);
listening, by the communication framework extension layer, to a state change of the Modem module by using the RIL, where the state change refers to change of a communication state;
reporting, by the communication framework extension layer, the state change to an application layer when the state change is listened to, to determine, by the application layer, a control operation determined by the state change, convert, by the application layer, the control operation into a control instruction, and issue, by the application layer, the control instruction to the communication framework extension layer; and
issuing, by the communication framework extension layer, the control instruction to the Modem module to enable the Modem module to respond to the control instruction.

In the method for implementing the non-intrusive communication service on the Android platform, the reporting of the state change to the application layer specifically includes:
reporting, by the communication framework extension layer, the state change to the application layer by using Inter-Process Communication (IPC) when the state change is listened to; determining, by the application layer, a prompt interface based on state information corresponding to the state change; receiving, by the application layer, a control operation based on the prompt interface; converting, by the application layer, the control operation into a control instruction; and issuing, by the application layer, the control instruction to the communication framework extension layer.

In the method for implementing the non-intrusive communication service on the Android platform, the issuing of the control instruction to the Modem module specifically includes:
detecting, by the communication framework extension layer, whether the control instruction needs to be issued to the Modem module; and
invoking, by the communication framework extension layer, an RIL interface corresponding to the control instruction to issue the control instruction to the Modem module by using the RIL interface when it is detected that the control instruction needs to be issued to the Modem module, to enable the Modem module to respond to the control instruction and feed back an execution result to the communication framework extension layer by using the RIL to feed back the execution result to the application layer by using the communication framework extension layer.

In the method for implementing the non-intrusive communication service on the Android platform, the method further includes:
executing, by the communication framework extension layer, the control operation in response to the control instruction when it is detected that the control instruction does not need to be issued to the Modem module, to feed back an execution result to the application layer by using the IPC.

In the method for implementing the non-intrusive communication service on the Android platform, the method further includes:
registering, by the application layer, a subclass of InCallService to enable the application layer to have a Car call management module function; and
listening, by the communication application layer, to a call to receive user feedback information and transmit the received user feedback information to the application layer.

A second aspect of the present disclosure provides a method for implementing a non-intrusive communication service on an Android platform, which is applied to a terminal device configured with a communication framework extension layer, where the method includes:
listening, by the communication framework extension layer, to a state change of the Modem module;
reporting, by the communication framework extension layer, the state change to an application layer when the state change is listened to, to determine, by the application layer, a control operation determined by the state change, convert, by the application layer, the control operation into a control instruction, and issue, by the application layer, the control instruction to the communication framework extension layer; and
issuing, by the communication framework extension layer, the control instruction to the Modem module to enable the Modem module to respond to the control instruction.

In the method for implementing the non-intrusive communication service on the Android platform, the method further includes: before the listening to the state change of the Modem module,
invoking a communication service stack loaded by a terminal device to load and initialize a communication framework by using the communication service stack; and
loading and initializing, by the communication framework, a communication framework extension layer with a reflection mechanism to enable the communication framework extension layer to invoke and register a Modem module by using a Radio Interface Layer (RIL);

In the method for implementing the non-intrusive communication service on the Android platform, where the listening to the state change of the Modem module specifically includes:
listening, by the communication framework extension layer, to a state change of the Modem module by using the RIL.

In the method for implementing the non-intrusive communication service on the Android platform, the reporting of the state change to the application layer specifically includes:
reporting, by the communication framework extension layer, the state change to the application layer by using Inter-Process Communication (IPC) when the state change is listened to; determining, by the application layer, a prompt interface based on state information corresponding to the state change; receiving, by the application layer, a control operation based on the prompt interface; converting, by the application layer, the control operation into a control instruction; and issuing, by the application layer, the control instruction to the communication framework extension layer.

In the method for implementing the non-intrusive communication service on the Android platform, the issuing of the control instruction to the Modem module specifically includes:
detecting, by the communication framework extension layer, whether the control instruction needs to be issued to the Modem module; and
invoking, by the communication framework extension layer, an RIL interface corresponding to the control instruction to issue the control instruction to the Modem module by using the RIL interface when it is detected that the control instruction needs to be issued to the Modem module, to enable the Modem module to respond to the control instruction and feed back an execution result to the communication framework extension layer by using the RIL to feed back the execution result back to the application layer by using the communication framework extension layer.

In the method for implementing the non-intrusive communication service on the Android platform, the method further includes:
executing, by the communication framework extension layer, the control operation in response to the control instruction when it is detected that the control instruction does not need to be issued to the Modem module, to feed back an execution result to the application layer by using the IPC.

In the method for implementing the non-intrusive communication service on the Android platform, the method further includes:
registering, by the application layer, a subclass of InCallService to enable the application layer to have a Car call management module function; and
listening, by the communication application layer, to a call to receive user feedback information and transmit the received user feedback information to the application layer.

In the method for implementing the non-intrusive communication service on the Android platform, the initializing of the communication framework extension layer includes:
invoking and initializing, by the IPC, a Phone core component, a sim lock component, and a core service component of the communication framework extension layer.

In the method for implementing the non-intrusive communication service on the Android platform, the method further includes: after initializing of the communication framework extension layer,
initializing by Binder, the application layer in the communication framework extension layer, where the application layer is preset.

In the method for implementing the non-intrusive communication service on the Android platform, where the application layer includes:
a Phone submodule for listening and responding to a state of a Phone in real time; and
a call submodule for listening and responding to a call state.

A third aspect of an embodiment of the present disclosure provides an apparatus for implementing an Android platform non-invasive communication service, including a communication framework extension layer, a Modem module, and an application layer; where the communication framework extension layer is configured to listen to a state change of the Modem module, report the state change to the application layer when the state change is listened to, and issue a control instruction to the Modem module; the application layer is configured to determine a control operation determined by the state change, convert the control operation into a control instruction, and issue the control instruction to the communication frame extension layer; and the Modem module is configured to execute the control operation.

In the apparatus for implementing the non-intrusive communication service on the Android platform, where the application layer includes:
a Phone submodule for listening and responding to a state of a Phone in real time; and
a call submodule for listening and responding to a call state.

In the apparatus for implementing the non-intrusive communication service on the Android platform, where call submodule is camouflaged as a Car call management module for listening to a call to receive user feedback information and transmit the received user feedback information to the communication framework extension layer.

A fourth aspect of an embodiment of the present disclosure provides a computer readable storage medium having stored one or more programs executable by one or more processors to implement operations of any one of the above-described methods for implementing the non-intrusive communication service on the Android platform.

A fifth aspect of an embodiment of the present disclosure provides a terminal device, including a processor, a memory, and a communication bus; the memory has stored thereon a computer readable program executable by the processor;
the communication bus enables connection communication between the memory and the processor; and
the processor implements operations of any one of the above-described methods for implementing the non-intrusive communication service on the Android platform when executing the computer readable program.

Advantageous Effects: compared with the relate art, the present disclosure provides a method for implementing an non-intrusive communication service on an Android platform, including: listening, by the communication framework extension layer, to a state change of the Modem module; reporting, by the communication framework extension layer, the state change to an application layer when the state change is listened to, to determine, by the application layer, a control operation determined by the state change, convert, by the application layer, the control operation into a control instruction, and issue, by the application layer, the control instruction to the communication framework extension layer; and issuing, by the communication framework extension layer, the control instruction to the Modem module to enable the Modem module to respond to the control instruction. The communication framework extension layer is superimposed on an Android communication architecture in the present disclosure to realize listening and responding to the communication state in real time with the communication framework extension layer, so that the communication between a secondary development function and the communication service stack can be realized by the communication framework extension layer without changing the communication service stack, thereby meeting the requirements for the secondary development of a region, an operator, a customer, and the like.

### DESCRIPTION OF THE DRAWINGS

In order to more clearly illustrate the technical solutions in embodiments of the present disclosure, the accompanying drawings depicted in the description of the embodiments will be briefly described below. It will be apparent that the accompanying drawings in the following description are merely some embodiments of the present disclosure, and other drawings may be obtained from these drawings without creative effort by those skilled in the art.

FIG. 1 is a flowchart of a method for implementing an Android platform non-invasive communication service according to the present disclosure.

FIG. 2 is an example diagram of an initialization flow in a method for implementing an Android platform non-invasive communication service according to the present disclosure.

FIG. 3 is a schematic flow diagram of a call state response process in a method for implementing an Android platform non-invasive communication service according to the present disclosure.

FIG. 4 is a schematic structural diagram of a terminal device according to the present disclosure.

### DETAILED DESCRIPTION

The present disclosure provides a method for implementing an Android platform non-invasive communication service. To make the objectives, technical solutions, and effects of the present disclosure more clear and definite, the present disclosure is illustrated in detail below by referring to the accompanying drawings and illustrating the embodiments. It should be understood that the specific embodiments described here are only used to explain the present disclosure, and are not used to limit the present disclosure.

Those skilled in the art can understand that, as used herein, the singular forms “a”, “an”, “said” and “the” may include the plural forms as well, unless expressly stated otherwise. It should be further understood that the word “comprise” when used in this specification of the present disclosure is taken to specify the presence of the features, integers, steps, operations, elements, and/or components, but does not preclude the presence or addition of one or more other features, integers, steps, operations, elements, components, and/or combination thereof. It should be understood that when an element is referred to as being “connected” or “coupled” to another element, it can be directly connected or coupled to the other element or an intervening element may also be present. Furthermore, “connected” or “coupled” as used herein may include wireless connection or wireless coupling. As used herein, the phrase “and/or” includes all or any element and all combinations of one or more of the associated listed items.

Those skilled in the art can understand that, unless otherwise defined, all terms (including technical and scientific terms) used herein have the same meanings as those commonly understood by those of ordinary skill in the art to which the disclosure belongs. It should also be understood that terms, such as those defined in commonly used dictionaries, should be interpreted as having a meaning that is consistent with the meaning of the context of the current technology and will not be interpreted in an idealized or overly formal sense unless defined as here.

In a particular implementation, a terminal device described in embodiments of the present disclosure includes, but not limited to, other portable devices such as a mobile phone having a touch sensitive surface (e.g., a touch display screen and/or touch pad), a laptop computer, or a tablet computer. It should further be understood in some embodiments that the device is not a portable communication device, but a desktop computer having a touch sensitive surface (e.g., a touch display screen and/or touch pad).

In the following discussion, a terminal device including a display and a touch sensitive surface is described. However, it should be understood that the terminal device may further include one or more other physical user interface devices such as a physical keyboard, a mouse, and/or a joystick.

The terminal device supports various applications, such as one or more of: a drawing application, a presentation application, a word processing application, a video conference application, a disc burning application, a spreadsheet application, a game application, a telephone application, a video conference application, an e-mail application, an instant messaging application, an exercise support application, a photo management application, a data camera application, a digital camera application, a web browsing application, a digital music player application, and/or a digital video playback application, and the like.

Various applications that may be executed on the terminal device may use at least one common physical user interface device, such as a touch sensitive surface. The first or more functions of the touch sensitive surface and the corresponding information displayed on the terminal may be adjusted and/or changed between and/or within the corresponding ones of the applications. As such, the common physical framework (e.g., a touch sensitive surface) of the terminal may support various applications having a user interface that is intuitive and transparent to a user.

It should be understood that the sequence numbers and sizes of the steps in the embodiments do not imply the order in which the steps are performed, and that the order in which the steps are performed is determined by their function and intrinsic logic, but should not constitute any limitation on the implementation of the embodiments of the present disclosure.

The inventors have found that, since 2019, Google has officially launched an Mainline plan, releasing a binary file of some of modules including a communication service stack (Telephony Stack) to one or more device vendors. For the device vendors, when the communication service stack is redeveloped and customized to meet the requirements of a region and an operator, it is necessary for the device vendors to submit requirement development codes to Google and use the requirement development codes after the requirement development codes are adopted by Google. However, a period of submitting the requirement development codes is longer and an adoption rate for the requirement development codes is lower, so that it is difficult to meet actual requirements.

In order to solve the above problems, a communication framework extension layer is added into the communication framework in the embodiments. The communication framework extension layer is configured to listen to a state change of the Modem module, and report the state change to the application layer when the state change is listened to. The application layer is configured to determine a control operation determined by the state change, convert the control operation into a control instruction, and issue the control instruction to the communication frame extension layer. The communication framework extension layer is configured to issue the control instruction to the Modem module to enable the Modem module to respond to the control instruction. The communication framework extension layer is superimposed on an Android communication architecture in the present disclosure to realize listening and responding to the communication state in real time with the communication framework extension layer, so that the communication between a secondary development function and the communication service stack can be realized by the communication framework extension layer without changing the communication service stack, thereby meeting the requirements for the secondary development of a region, an operator, a customer, and the like.

The present application will be further explained below through the description of the embodiments in conjunction with the drawings.

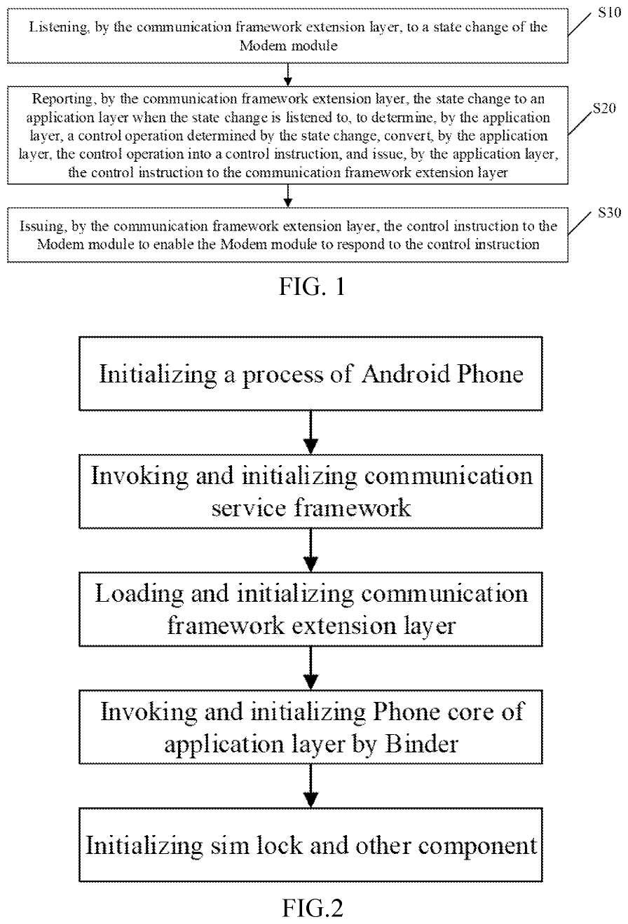

An embodiment of the present disclosure provides a method for implementing a non-intrusive communication service on an Android platform. As shown in FIG. 1, the method includes step S10-S30 as follows.

At step S10, the communication framework extension layer may listen to a state change of the Modem module.

Specifically, the communication framework extension layer is a communication framework extension layer superimposed into an Android communication architecture for listening to the state change of the Modem module in real time. The state change refers to change of a communication state, for example, a communication state change formed by answering a call, a communication state change formed by hanging up, and the like. It should be understood that the state change refers to a change of the communication state at the current moment with respect to the communication state of the previous moment. In addition, the communication frame extension layer may be communicated with the Modem module by a Radio Interface Layer (RIL), where the Modem module may be a modem chip or the like, and different communication modes may use different Modem chips.

In an implementation of the present embodiment of the present disclosure, as shown in FIG. 2, the method further includes: before the listening to the state change of the Modem module,
invoking a communication service stack loaded by a terminal device to load and initialize a communication framework by using the communication service stack; and
loading and initializing, by the communication framework, a communication framework extension layer with a reflection mechanism to enable the communication framework extension layer to invoke and register a Modem module by using a Radio Interface Layer (RIL);

Specifically, the communication framework may be a communication framework built at a Framework layer in the Android system loaded by the terminal device for providing a developer with an ability to operate a communication transaction. The RIL is an intermediate layer for adapting a Modem chip, through which a Modem instruction of a Modem module can be converted into a data stream available in Java. The communication framework may load and initialize the communication framework layer by using a reflection mode, where components of the communication framework extension layer such as a Phone core, a sim lock, and a core service can be invoked and initialized by using the Inter-Process Communication (IPC) while initializing the communication framework extension layer. In addition, after the communication framework extension layer is initialized, an application layer is initialized by Binder in the communication framework extension layer. The application layer is preset, and the application layer includes a Phone submodule and a call submodule. The Phone submodule is accessed and initialized by a cross-process mode inside the communication framework extension layer, configured to listen and respond to a Phone state in real time, and communicated with the Modem module by the RIL. The call submodule may be configured to be camouflaged as a conventional Car call management module to listen to a call state and obtain call information, and may be integrated within a system or coexist with Dialer/InCallUI of a third party.

In one implementation of the embodiments of the present disclosure, since the communication framework extension layer may be communicated with the Modem module by the RIL, the communication framework extension layer may specifically listen to the state change of the Modem module by listening, by the communication framework extension layer, to the state change of the Modem module by using the RIL. In addition, before the communication framework extension layer listens to the state change of the Modem module by using the RIL, the communication framework extension layer invokes and registers the Modem module by using the RIL, so that the communication framework extension layer can listen to the state change of the Modem module by using the RIL.

At step S20: the communication framework extension layer may report the state change to an application layer when the state change is listened to, to determine, by the application layer, a control operation determined by the state change, convert, by the application layer, the control operation into a control instruction, and issue, by the application layer, the control instruction to the communication framework extension layer; and

Specifically, the control operation is a control operation determined based on the state change, where the control operation may be input by a user, may be formed by a controller, or the like. The control instruction is configured to be issued to the communication framework extension layer, so that the communication framework extension layer transmits the control instruction to the Modem module or responds to the control instruction. It can be understood that, when the communication framework extension layer receives the state change, the communication framework extension layer obtains and reports the state change to the application layer; the application layer determines a control operation determined by the state change, converts the control operation into a control instruction recognizable by the communication framework extension layer, and issues the control instruction to the communication framework extension layer, so that the communication framework extension layer can respond to the control instruction or issue the control instruction to the Modem module to enable the Modem module to respond to the control instruction, so that the terminal device can respond to the control operation.

In one implementation of the embodiments of the present disclosure, the reporting of the state change to the application layer when the state change is listened to, to determine, by the application layer, a control operation determined by the state change, convert the control operation into a control instruction, and issue the control instruction to the communication framework extension layer may be specifically implemented by:
reporting, by the communication framework extension layer, the state change to the application layer by using Inter-Process Communication (IPC) when the state change is listened to; determining, by the application layer, a prompt interface based on state information corresponding to the state change; receiving a control operation based on the prompt interface; converting the control operation into a control instruction; and issuing the control instruction to the communication framework extension layer.

Specifically, the state information is a detailed state of the state change and may be read by the IPC. Whether the state information triggers an external operation can be detected based on the detailed state. When the external operation is triggered, the application layer may form a prompt interface, and when the external operation is not triggered, the state change can be ignored or discarded, or the like. In addition, when the external operation is triggered, the application layer may detect whether the prompt interface is displayed on the terminal device. If the prompt interface is displayed on the terminal device, the prompt interface is updated. If the prompt interface is not displayed on the terminal device, the prompt interface is created and displayed to receive a control operation input from the external by using the prompt interface. After the control operation is obtained, the application layer converts the control operation into a control instruction, and issues the control instruction to the communication framework extension layer by using the IPC, so that the communication framework extension layer obtains the control instruction.

At step S30, the communication framework extension layer may issue the control instruction to the Modem module to enable the Modem module to respond to the control instruction.

Specifically, after receiving the control instruction, the communication framework extension layer parses the control instruction to determine whether the control instruction needs to be issued to the Modem module, so as to determine whether the control instruction needs to be issued to the Modem module to respond to the control instruction by the Modem module. In one implementation of the embodiments of the present disclosure, the issuing, by the communication framework extension layer, the control instruction to the Modem module to enable the Modem module to respond to the control instruction may be specifically implemented by:
detecting, by the communication framework extension layer, whether the control instruction needs to be issued to the Modem module; and
invoking, by the communication framework extension layer, an RIL corresponding to the control instruction to issue the control instruction to the Modem module by using the RIL when it is detected that the control instruction needs to be issued to the Modem module, to enable the Modem module to respond to the control instruction and feed back an execution result to the communication framework extension layer by using the RIL to feed back the execution result to the application layer by using the communication framework extension layer; and
executing, by the communication framework extension layer, the control operation in response to the control instruction when it is detected that the control instruction does not need to be issued to the Modem module, to feed back an execution result to the application layer by using the IPC.

Specifically, when the control instruction is obtained, a RIL interface corresponding to the control instruction is determined, and the determined RIL interface is invoked to issue the control instruction to the Modem module by using the RIL. After receiving the control instruction, the Modem module responds to the control instruction to execute the control operation corresponding to the control instruction, and feeds back a control result to the communication framework extension layer by using the RIL, so that the communication framework extension layer feeds back an operation result to the application layer. In addition, when it is detected that the control instruction does not need to be issued to the Modem module, the communication framework extension layer direct responds to the control instruction to execute the control operation, and feeds back an execution result to the application layer by using the IPC.

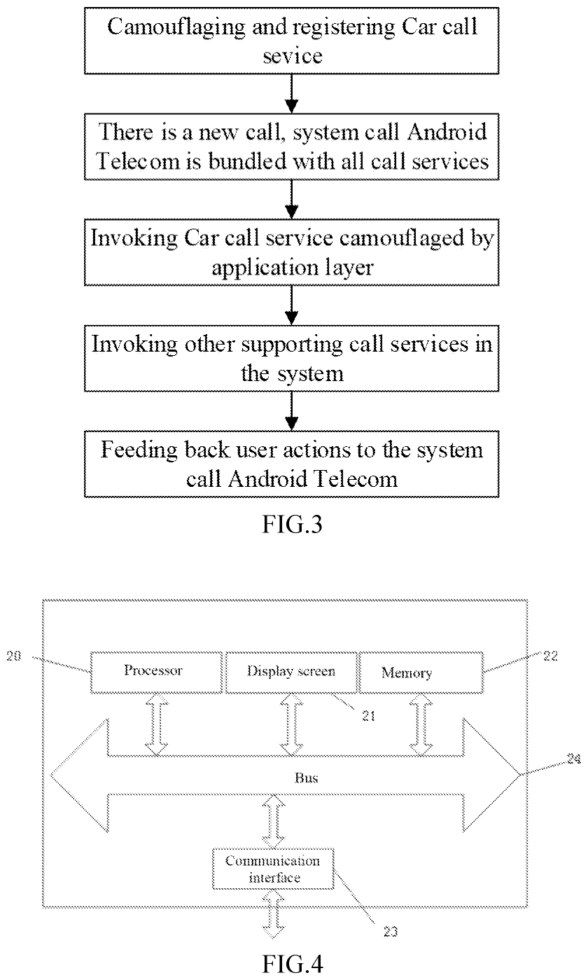

In one implementation of the embodiments of the present disclosure, as shown in FIG. 3, the method further includes:
registering, by the application layer, a subclass of InCallService to enable the application layer to have a Car call management module function; and
listening, by the communication application layer, to a call to receive user feedback information and transmit the received user feedback information to the communication framework extension layer.

Specifically, the sub-class of the InCallService is registered by the application layer so that the application layer can be camouflaged as a Car call management module for listening to a call state and obtain call information. The application layer includes a call submodule, where the call submodule registers the sub-class of the InCallService and is camouflaged as the Car call management module. In addition, the application layer is camouflaged as a Car call management module so that the Car call management module may be integrated within a system or coexist with Dialer/InCallUI of a third party. A user does not perceive its presence because a workflow in which the application layer is camouflaged as a Car call management module is the same as that of the ordinary InCallUI, but the registration and notification are both later than the ordinary user-visible InCallUI, and do not have an impact on timing and performance of the Dialer of the third party.

In addition, the Car call service camouflaged by the application layer coexists with other Car call services and the system default call service, and is authorized to obtain and modify the call. The Car call service camouflaged by the application layer may listen to addition and removal of a call, thereby registering and/or unregistering the state change of each call; register content changes such as information, states, events, and members of a listening call, and determines, based on the content changes and/or the state changes, whether a response operation needs to be performed; perform a user interaction feedback if a response operation needs to be performed, such as playing a sound, a vibration, a pop-up prompt, and the like. After the user interaction feedback is performed, an interaction operation that the user feeds back is encapsulated and returned to the application layer. Then, the application layer can feed back a result to an observer. The present embodiment utilizes a management service provided for a conventional in-vehicle device in an existing Android call service system, and implements integration of an Android device server end and a simulated in-vehicle device end in an Android device in a reverse direction, thereby achieving the purpose of no perception and non-intrusion of a user.

In one implementation of the embodiments of the present disclosure, the application layer may include: a Phone submodule for listening and responding to the state of the Phone in real time; and a call submodule for listening and responding to the state of the call. It should be understood that the Phone submodule is configured to perform the steps S10-S30, and the call submodule is configured to be camouflaged as a Car call management module for listening to a call to receive user feedback information and transmit the received user feedback information to the communication framework extension layer. As such, the communication framework extension layer can listen and respond to the state of the Phone in real time while listening and responding to the state of the call. In this way, the communication framework extension layer can be used for subsequent secondary development and customization for the requirements of the region, the operator and the customer without changing the current Telephony module.

Based on the above-described method for implementing an Android platform non-invasive communication service, another embodiment of the present disclosure further provides an apparatus for implementing an Android platform non-invasive communication service, including a communication framework extension layer, a Modem module, and an application layer; where the communication framework extension layer is configured to listen to a state change of the Modem module, report the state change to the application layer when the state change is listened to, and issue a control instruction to the Modem module; the application layer is configured to determine a control operation determined by the state change, convert the control operation into a control instruction, and issue the control instruction to the communication frame extension layer; and the Modem module is configured to execute the control operation.

Based on the above-described method for implementing an Android platform non-invasive communication service, yet another embodiment of the present disclosure provides a computer readable storage medium having stored one or more programs executable by one or more processors to implement operations of any one of the methods for implementing the non-intrusive communication service on the Android platform described in the above embodiments.

Based on the above-described method for implementing an Android platform non-invasive communication service, the present disclosure further provides a terminal device. As shown in FIG. 4, the terminal device may include: at least one processor 20; a display screen 21; and a memory 22. The terminal device may further include a communication interface 23 and a bus 24. The processor 20, the display screen 21, the memory 22 and the communications interface 23 may communicate with each other via the bus 24. The display screen 21 is configured to display a user guide interface preset in an initial setting mode. The communication interface 23 may be configured to transmit information. The processor 20 may invoke logical instructions in the memory 22 to perform any of the methods in the embodiments described above.

Furthermore, the logic instructions in the memory 22 described above may be implemented in the form of a software functional unit, and stored in a computer-readable storage medium when sold or used as a stand-alone product.

The memory 22, as a computer-readable storage medium, may be configured to store software programs, computer-executable programs, program instructions or modules corresponding to the methods in the embodiments of the present disclosure. The processor 20 executes the functional applications and the data processing, i.e. implements the methods in the embodiments described above, by running software programs, instructions or modules stored in the memory 22.

The memory 22 may include a storage program area and a storage data area, where the storage program area may store an operating system, an application program required by at least one function, and the like; and the storage data area may store data or the like created according to the use of the terminal device. In addition, memory 22 may include a high speed random access memory, and may also include a non-volatile memory. For example, a U disk, a removable hard disk, a read-only memory (ROM), a random-access memory (RAM), a magnetic disk, or an optical disk may store program code or may be a transient storage medium.

In addition, a specific operation process of the apparatus for implementing the non-intrusive communication service on the Android platform, and a specific processes loaded and executed by the above-described storage medium and the multiple instruction processors in the terminal device have been described in detail in the above-described method and will not be repeatedly set forth herein.

Finally, it should be noted that the aforesaid embodiments are only intended to explain but not to limit the technical solutions of the present disclosure. Although the present disclosure has been explained in detail with reference to the above-described embodiments, the person of ordinary skill in the art may understand that, the technical solutions described in each of the embodiments mentioned above may still be amended, or some technical features in the technical solutions may be replaced equivalently; these amendments or equivalent replacements, which doesn't cause the essence of the corresponding technical solution to be broken away from the spirit and the scope of the technical solution in various embodiments of the present disclosure, should all be included in the protection scope of the present disclosure.

1. A method for implementing a non-intrusive communication service on an Android platform, wherein the method is applied to a terminal device configured with a communication framework extension layer, and the method comprises:
invoking a communication service stack loaded by the terminal device to load and initialize a communication framework by using the communication service stack; and
loading and initializing, by the communication framework, a communication framework extension layer with a reflection mechanism to enable the communication framework extension layer to invoke and register a Modem module by using a Radio Interface Layer (RIL);
listening, by the communication framework extension layer, to a state change of the Modem module by using the RIL, wherein the state change refers to change of a communication state;
reporting, by the communication framework extension layer, the state change to an application layer when the state change is listened to, to determine, by the application layer, a control operation determined by the state change, convert, by the application layer, the control operation into a control instruction, and issue, by the application layer, the control instruction to the communication framework extension layer; and
issuing, by the communication framework extension layer, the control instruction to the Modem module to enable the Modem module to respond to the control instruction.

2. The method of claim 1, wherein the reporting of the state change specifically comprises:
reporting, by the communication framework extension layer, the state change to the application layer by using Inter-Process Communication (IPC) when the state change is listened to; determining, by the application layer, a prompt interface based on state information corresponding to the state change; receiving, by the application layer, a control operation based on the prompt interface; converting, by the application layer, the control operation into a control instruction; and issuing, by the application layer, the control instruction to the communication framework extension layer.

3. The method of claim 1, wherein the issuing of the control instruction to the Modem module specifically comprises:
detecting, by the communication framework extension layer, whether the control instruction needs to be issued to the Modem module; and
invoking, by the communication framework extension layer, an RIL interface corresponding to the control instruction to issue the control instruction to the Modem module by using the RIL interface when it is detected that the control instruction needs to be issued to the Modem module, to enable the Modem module to respond to the control instruction and feed back an execution result to the communication framework extension layer by using the RIL to feed back the execution result to the application layer by using the communication framework extension layer.

4. The method of claim 3, further comprising:
executing, by the communication framework extension layer, the control operation in response to the control instruction when it is detected that the control instruction does not need to be issued to the Modem module, to feed back an execution result to the application layer by using the IPC.

5. The method of claim 1, further comprising:
registering, by the application layer, a subclass of InCallService to enable the application layer to have a Car call management module function; and
listening, by the communication application layer, to a call to receive user feedback information and transmit the received user feedback information to the application layer.

6. A method for implementing a non-intrusive communication service on an Android platform, wherein the method is applied to a terminal device configured with a communication framework extension layer, and the method comprises:
listening, by the communication framework extension layer, to a state change of the Modem module;
reporting, by the communication framework extension layer, the state change to an application layer when the state change is listened to, to determine, by the application layer, a control operation determined by the state change, convert, by the application layer, the control operation into a control instruction, and issue, by the application layer, the control instruction to the communication framework extension layer; and
issuing, by the communication framework extension layer, the control instruction to the Modem module to enable the Modem module to respond to the control instruction.

7. The method of claim 6, further comprising: before the listening to the state change of the Modem module,
invoking a communication service stack loaded by the terminal device to load and initialize a communication framework by using the communication service stack; and
loading and initializing, by the communication framework, a communication framework extension layer with a reflection mechanism to enable the communication framework extension layer to invoke and register a Modem module by using a Radio Interface Layer (RIL);

8. The method of claim 6, wherein the listening to the state change of the Modem module specifically comprises:
listening, by the communication framework extension layer, to a state change of the Modem module by using the RIL.

9. The method of claim 6, wherein the reporting of the state change specifically comprises:
reporting, by the communication framework extension layer, the state change to the application layer by using Inter-Process Communication (IPC) when the state change is listened to; determining, by the application layer, a prompt interface based on state information corresponding to the state change; receiving, by the application layer, a control operation based on the prompt interface; converting, by the application layer, the control operation into a control instruction; and issuing, by the application layer, the control instruction to the communication framework extension layer.

10. The method of claim 6, wherein the issuing of the control instruction to the Modem module specifically comprises:
detecting, by the communication framework extension layer, whether the control instruction needs to be issued to the Modem module; and
invoking, by the communication framework extension layer, an RIL interface corresponding to the control instruction to issue the control instruction to the Modem module by using the RIL interface when it is detected that the control instruction needs to be issued to the Modem module, to enable the Modem module to respond to the control instruction and feed back an execution result to the communication framework extension layer by using the RIL to feed back the execution result to the application layer by using the communication framework extension layer.

11. The method of claim 10, further comprising:
executing, by the communication framework extension layer, the control operation in response to the control instruction when it is detected that the control instruction does not need to be issued to the Modem module, to feed back an execution result to the application layer by using the IPC.

12. The method of claim 6, further comprising:
registering, by the application layer, a subclass of InCallService to enable the application layer to have a Car call management module function; and
listening, by the communication application layer, to a call to receive user feedback information and transmit the received user feedback information to the application layer.

13. The method of claim 7, wherein the initializing of the communication framework extension layer comprises:
invoking and initializing, by Inter-Process Communication (IPC), a Phone core component, a sim lock component, and a core service component of the communication framework extension layer.

14. The method of claim 7, further comprising: after the initializing of the communication framework extension layer,
initializing, by Binder, the application layer in the communication framework extension layer, wherein the application layer is preset.

15. The method of claim 14, wherein the application layer comprises:
a Phone submodule for listening and responding to a state of a Phone in real time; and
a call submodule for listening and responding to a call state.

16. An apparatus for implementing a non-invasive communication service on an Android platform, comprising: a communication framework extension layer, a Modem module, and an application layer; wherein the communication framework extension layer is configured to listen to a state change of the Modem module, report the state change to the application layer when the state change is listened to, and issue a control instruction to the Modem module; the application layer is configured to determine a control operation determined by the state change, convert the control operation into a control instruction, and issue the control instruction to the communication frame extension layer; and the Modem module is configured to execute the control operation.

17. The apparatus of claim 16, wherein the application layer comprises:
a Phone submodule for listening and responding to a state of a Phone in real time; and
a call submodule for listening and responding to a call state.

18. The apparatus of claim 17, wherein the call submodule is camouflaged as a Car call management module for listening to a call to receive user feedback information and transmit the received user feedback information to the communication framework extension layer.

19. A non-transitory computer readable storage medium having stored one or more programs executable by one or more processors to implement operations of the method of claim 6.

20. A terminal device, comprising: a processor, a memory, and a communication bus; wherein the memory has stored thereon a computer readable program executable by the processor;
the communication bus enables connection communication between the memory and the processor; and
the processor implements operations of the method of claim 6 when executing the computer readable program.
